(19) United States
(12) Patent Application Publication
(10) Pub. No.: US 2013/0086611 A1
(43) Pub. Date: Apr. 4, 2013

(54) DYNAMIC HEADER IN AN INTERACTIVE APPLICATION ON TELEVISION

(71) Applicants: Swati Prashant Bankar, Pune (IN); Madhusudhanan Natarajan, Krishnagiri (IN); Mohit Srivastava, Rameshwarpuri (IN)

(72) Inventors: Swati Prashant Bankar, Pune (IN); Madhusudhanan Natarajan, Krishnagiri (IN); Mohit Srivastava, Rameshwarpuri (IN)

(73) Assignee: INFOSYS LIMITED, Bangalore (IN)

(21) Appl. No.: 13/403,939

(22) Filed: Feb. 23, 2012

(30) Foreign Application Priority Data
Sep. 29, 2011 (IN) 3382/CHE/2011

(51) Int. Cl. H04N 21/482

(52) U.S. Cl. 725/38

(57) ABSTRACT

A system and method for navigating using a dynamic header in an interactive application of a television having a number of modules are described. Among all the modules of the interactive application, one or more desired modules are determined by analyzing at least one parameter (either based on user input or default values set by system). References to the determined desired modules are added in the dynamic header. The dynamic header is displayed in the interactive application of the television and the user is enabled to navigate in the interactive application using the dynamic header.

### RELATED APPLICATION DATA

This application claims priority to Indian Patent Application No. 3382/CHE/2011, filed Sep. 29, 2011, which is hereby incorporated by reference in its entirety.

### FIELD OF THE INVENTION

The present disclosure relates in general to interactive applications on television. In particular, the invention discloses a method and system to implement a dynamic header of an interactive application on television.

### BACKGROUND

As is known in the art, a television typically refers to a telecommunication medium that transmits, receives, and displays moving images and sound. Previously, a television used to only display moving images with sound at a pre-defined schedule. Therefore, for example, if a user had to watch a movie on the television, he could only watch the movie at the time when the movie was scheduled to be broadcasted by the service provider (a provider providing/transmitting/broadcasting moving images to be received by the television).

Today, interactive television has replaced the previous version of televisions. Generally, an interactive television is a television where information flows not only from the service provider to the user, but also back from the user to the service provider. The interactive television has a number of interactive applications that allow the user to interact with the television or with the television content as they view it. Such interactive applications may include features such as user playing along with quizzes broadcasted by the service provider, choosing different camera angles during events, user taking part in discussions and commenting on events through message boards, user storing any broadcasted movies/pictures/content for future view, and the like.

An interactive application generally consists of a number of modules. As used herein, the term ‘module’ may refer to a file that contains data/information such as, for example, a folder, a text file, a video file, an audio file, an image file, and so forth. When a user navigates from one module to another, he generally first comes out of the current module to move into another module. The user typically navigates out of the present module using a Back button, which takes the user to the previous module accessed by the user. For example, say an interactive application has two folders named FOLDER1 and FOLDER2. FOLDER1 further has a SUB FOLDER1 that has a video file in it. Now, if the user has taken the path FOLDER1→SUB FOLDER1→video file to run the video file and he wants to go to FOLDER 2, then he has to go back the path SUB FOLDER1→FOLDER1→FOLDER2 using back button. Taking a scenario where there are a large number of modules in the interactive application, navigation to different module is tiresome and complex.

Thus, there is a general need to enable a user to easily navigate in an interactive application of a television. Several aspects of the present disclosure facilitate faster and easier navigation within an interactive application of a television.

### SUMMARY OF THE INVENTION

The present disclosure discloses a method for navigating using a dynamic header in an interactive application having a number of modules in a television. Among all modules of the interactive application, desired modules are determined by analyzing at least one parameter. References to the determined desired modules are added in the dynamic header. The dynamic header is displayed in the interactive application of the television and the user is enabled to navigate in the interactive application using the dynamic header. The reference specifies location of the at least one desired module.

The present disclosure further discloses a system for navigating using a dynamic header in an interactive application of a television. The system comprises a storage unit, an analyzing unit and a displaying unit. The storage unit is configured to store various modules of the interactive application. The analyzing unit is configured to analyze at least one parameter to determine desired modules among the modules. The displaying unit is configured to display the dynamic header, which includes the references to the desired modules.

### BRIEF DESCRIPTION OF THE DRAWINGS

These and other features, aspects, and advantages of the present disclosure will be better understood when the following detailed description is read with reference to the accompanying drawings in which like characters represent like parts throughout the drawings, wherein:

FIG. 1 is an illustrative diagram explaining the navigation in an interactive application of a television using a dynamic header, in accordance with an embodiment of the present invention;

FIG. 2 is a block diagram illustrating the details of an example system 200 enabling a user to navigate in an interactive application of a television using a dynamic header in which several aspects of the present disclosure can be implemented;

FIG. 3 is an example embodiment according to an aspect of the present disclosure; and

FIG. 4 is a system illustrating a generalized computer network arrangement, in accordance with an embodiment of the present technique.

### DETAILED DESCRIPTION

The following description is the full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to get an advantage without the corresponding use of other features described in the following paragraphs. As such, the present description should be considered as merely illustrative of the principles of the present technique and not in limitation thereof, since the present technique is defined solely by the claims.

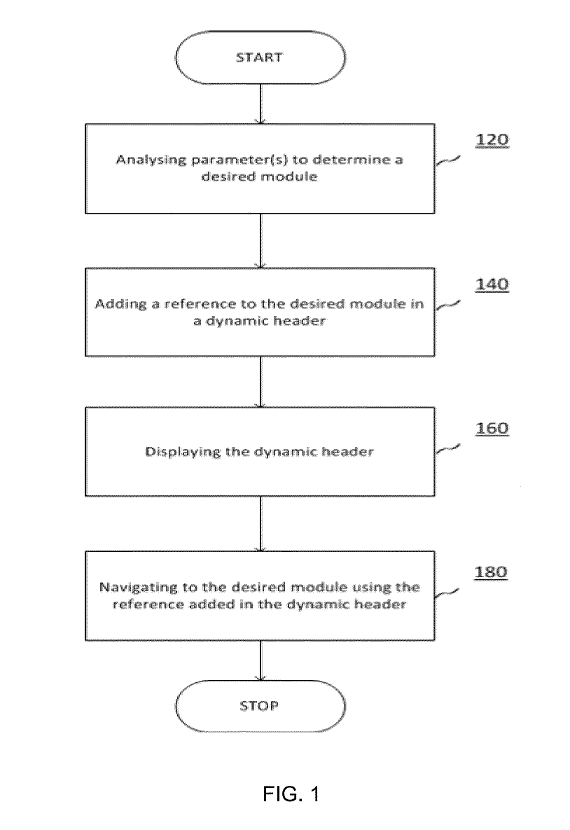

FIG. 1 is an illustrative diagram explaining the navigation in an interactive application of a television using a dynamic header, in accordance with an embodiment of the present invention. As used in this disclosure, a user is a person who uses the interactive application of the television. Generally, the interactive application receives user input and processes the interactive content accompanied with the standard broadcast. The disclosure discloses a dynamic header in the interactive application of the television for navigation (step 180). As used herein, the term ‘header’ refers to a navigator having references to access other modules/components of the application.

The dynamic header displays references of different desired modules. It will be understood that this dynamic feature adds value to the television, since a user can go back to any desired module directly, that is, not necessarily in a sequential manner (as it happens in “Back” button functionality). It should be noted that, typically, a reference is a link which specifies the location of the desired module. When the user selects the reference of a desired module, the control goes to the desired module. As used herein, a desired module is a module among all the modules of the interactive application, which is determined after analyzing one or more parameters (step 120). These parameters can be based on various factors including, but not limited to, time spent on a module by the user, preferences of the user, modules used by the user, or combinations thereof. For example, if a data of one month has been analyzed for a given user and it is found that the user frequently used File XYZ and Video 2, then the header can be set to display a reference to File XYZ and Video 2. Therefore, if the user is in a particular module and wants to open File XYZ, he can directly open the File XYZ by using the reference to File XYZ in the dynamic header.

In one embodiment, analysis of parameters is performed continuously and accordingly desired modules are determined and reference to the desired module is added to the dynamic header (step 140). In another embodiment, the user is enabled to set any module as the desired module for which he wants the reference in the dynamic header. For example, if a user is watching a sports channel and wants to keep switching with a movie channel, the user can set the movie channel as the desired module and this will add the reference to the movie channel in the dynamic header so that the user can directly access the movie channel from the sports channel. In yet another embodiment, the dynamic header may be displayed anywhere on the screen of the television (step 160). For example, the dynamic header can be displayed as footer or as a side-bar. The user may now navigate to any of the desired modules using the reference of the corresponding desired module, added to the dynamic header (step 180).

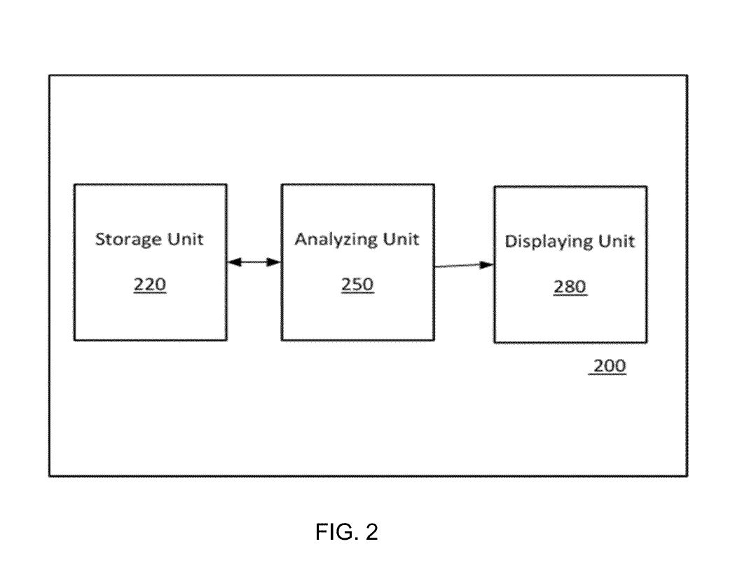

FIG. 2 is a block diagram illustrating the details of an example system 200 enabling a user to navigate in an interactive application of a television using a dynamic header in which several aspects of the present disclosure can be implemented. System 200 includes a storage unit 220, an analyzing unit 250 and a displaying unit 280.

Storage unit 220 may store various modules of the interactive application (not shown in the figure). In one embodiment, storage unit 220 may also store data received from the user. Further, the user may also set some data as per his/her preference. Analyzing unit 250 analyses one or more parameters stored at storage unit 220 to determine desired modules among the modules stored in storage unit 220. In one embodiment, values of one or more of the parameters may be set by the user. Likewise the user may set his/her preference for the modules. These parameters may be based on factors including, but not limited to, time spent on a module by the user, preferences of the user, the modules used by the user or combinations thereof.

Display unit 280 displays a dynamic header comprising reference of the determined desired modules. In one embodiment, display unit 280 may display the dynamic header as a side-bar or as footer. In one embodiment, a user interface (of the interactive application) is enabled to receive input from the user to set the value of one or more parameters.

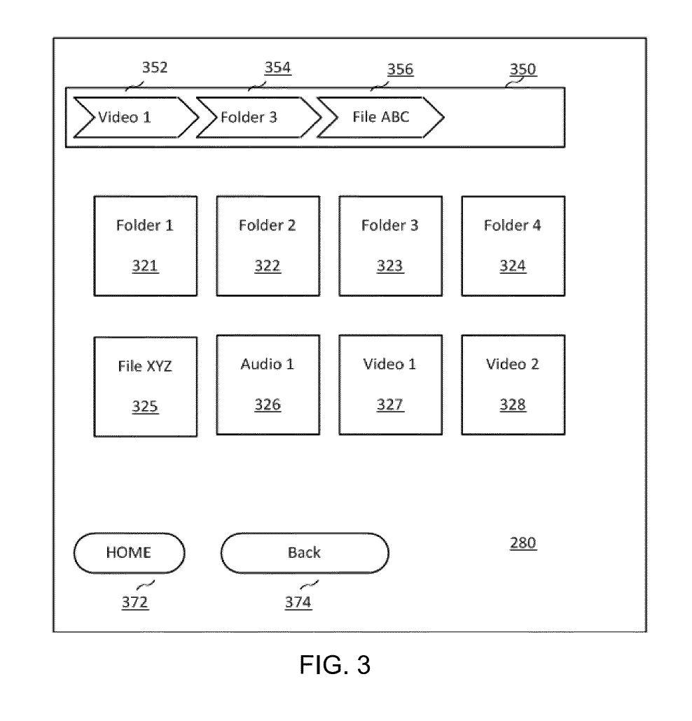

FIG. 3 is an example embodiment according to an aspect of the present disclosure. Display unit 280 displaying the dynamic header (350), different modules (Folder 1 (321), Folder 2 (322), Folder 3 (323), Folder 4 (324), File XYZ (325), Audio 1 (326), Video 1 (327) and Video 2 (328)), Home (372) and Back (374) buttons is shown. Folder 1 (321), Folder 2 (322), Folder 3 (323), Folder 4 (324), File XYZ (325), Audio 1 (326), Video 1 (327) and Video 2 (328) are the modules of the interactive application stored in storage unit 220. Home (372) button enables the user to return to the first page (the page set as default to be opened when the user starts the interactive application) of the interactive application. Back (374) button enables the user to go back to the previous module he had accessed.

Dynamic header 350 having references to the desired modules (Video 1 (352), Folder 3 (354), File ABC (356)) is shown. It will be understood that these references are added to dynamic header 350 after analysis of the parameters stored in storage unit 220 and determining desired modules among all the modules of the interactive application. In one embodiment, the references may keep changing continuously based on the change in the value of the parameters. For example, say one of the parameters is frequency of use of the modules by the user. If the frequency of Folder 1 is highest today, the reference of the same (Folder 1 being the desired module having the highest frequency) will be added to the dynamic header. However, if the frequency of Folder 1 decreases subsequently, its reference may not be added to the dynamic header. By selecting these references, the corresponding module may be directly opened without going back to the home. This saves a lot of time and effort of a user.

In another embodiment, if the user has set his preference for, say, Folder 3 and Folder 4 as desired modules, a reference to these modules is added to dynamic header 350 so that the user gets a direct access to these modules from the module he is currently in. Thus, there is considerable ease in accessing the user's preferred modules.

### Exemplary Computing Environment

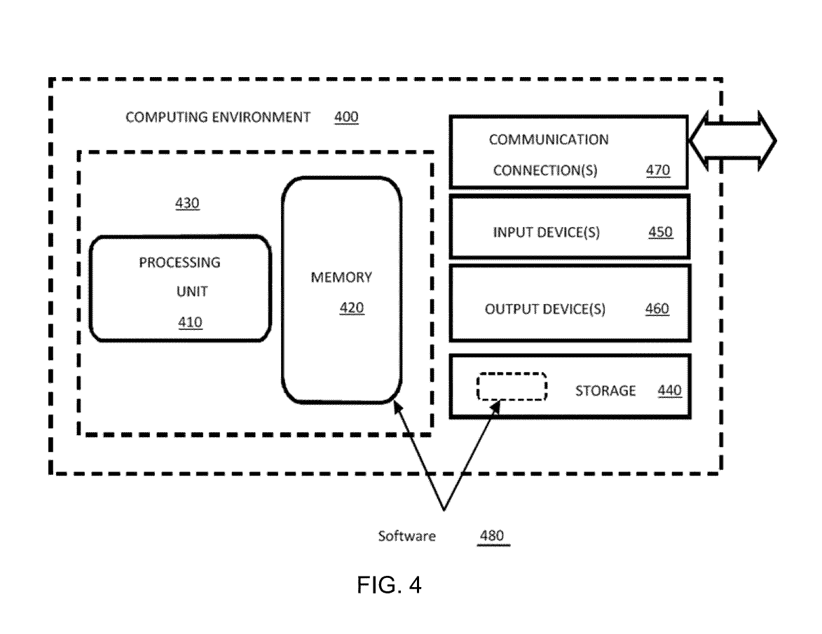

One or more of the above-described techniques may be implemented in or involve one or more computer systems. FIG. 4 illustrates a generalized example of a computing environment 400. The computing environment 400 is not intended to suggest any limitation as to scope of use or functionality of described embodiments.

With reference to FIG. 4, the computing environment 400 includes at least one processing unit 410 and memory 420. In FIG. 4, this most basic configuration 430 is included within a dashed line. The processing unit 410 executes computer-executable instructions and may be a real or a virtual processor. In a multi-processing system, multiple processing units execute computer-executable instructions to increase processing power. The memory 420 may be volatile memory (e.g., registers, cache, RAM), non-volatile memory (e.g., ROM, EEPROM, flash memory, etc.), or some combination of the two. In some embodiments, the memory 420 stores software 480 implementing described techniques.

A computing environment may have additional features. For example, the computing environment 400 includes storage 440, one or more input devices 450, one or more output devices 460, and one or more communication connections 470. An interconnection mechanism (not shown) such as a bus, controller, or network interconnects the components of the computing environment 400. Typically, operating system software (not shown) provides an operating environment for other software executing in the computing environment 400, and coordinates activities of the components of the computing environment 400.

The storage 440 may be removable or non-removable, and includes magnetic disks, magnetic tapes or cassettes, CD-ROMs, CD-RWs, DVDs, or any other medium which may be used to store information and which may be accessed within the computing environment 400. In some embodiments, the storage 440 stores instructions for the software 480.

The input device(s) 450 may be a touch input device such as a keyboard, mouse, pen, trackball, touch screen, or game controller, a voice input device, a scanning device, a digital camera, or another device that provides input to the computing environment 400. The output device(s) 460 may be a display, printer, speaker, or another device that provides output from the computing environment 400.

The communication connection(s) 470 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 400, computer-readable media include memory 420, storage 440, communication media, and combinations of any of the above.

Having described and illustrated the principles of our invention with reference to described embodiments, it will be recognized that the described embodiments may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiments shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method for navigating using a dynamic header in an interactive application of a television wherein the interactive application comprises a plurality of modules, the method comprising:
analyzing at least one parameter to determine at least one desired module among the plurality of modules;
adding a reference of the at least one desired module in the dynamic header, wherein the dynamic header comprises at least one reference to the at least one desired module;
displaying the dynamic header in the interactive application of the television; and
enabling a user to navigate to the at least one desired module using the at least one reference displayed in the dynamic header.

2. The method of claim 1, wherein the at least one parameter comprises one or more of time spent on a module by the user, user preference, and modules used by the user.

3. The method of claim 1, wherein the plurality of modules comprises one or more of folders, text files, video files, and audio files.

4. The method of claim 1, wherein the at least one reference specifies the location of the at least one desired module.

5. A system for navigating using a dynamic header in an interactive application of a television, the system comprising:
a storage unit configured to store a plurality of modules of the interactive application;
an analyzing unit configured to analyze at least one parameter to determine at least one desired module among the plurality of modules; and
a displaying unit configured to display the dynamic header comprising at least one reference to the at least one desired module, wherein the dynamic header is displayed in the interactive application.

6. The system of claim 5, wherein the at least one parameter comprises one or more of time spent on a module by the user, user preference, and modules used by the user.

7. The system of claim 5, wherein the plurality of modules comprises one or more of folders, text files, video files, and audio files.

8. The system of claim 5, wherein the at least one reference specifies the location of the at least one desired module.

9. A computer program product comprising a computer usable medium having a computer readable code embodied therein for navigating using a dynamic header in an interactive application of a television wherein the interactive application comprises of a plurality of modules, the computer program product comprising:
program code adapted for analyzing at least one parameter to determine at least one desired module among the plurality of modules;
program code adapted for adding a reference to the at least one desired module in the dynamic header wherein the dynamic header comprises at least one reference to the at least one desired module;
program code adapted for displaying the dynamic header in the interactive application of the television; and
program code adapted for enabling a user to navigate to the at least one desired module using the at least one reference displayed in the dynamic header.

10. The computer program product of claim 9, wherein the at least one parameter comprises one or more of time spent on a module by the user, user preference, and modules used by the user.

11. The computer program product of claim 9, wherein the plurality of modules comprises one or more of folders, text files, video files, and audio files.

12. The computer program product of claim 9, wherein the at least one reference allows access to the at least one desired module.
